(19) United States
(12) Patent Application Publication
(10) Pub. No.: US 2010/0117304 A1
(43) Pub. Date: May 13, 2010

(54) PISTON RING

(76) Inventors: Johannes Esser, Odenthal (DE); Frank Münchow, Wermelskirchen (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/527,023

(22) PCT Filed: Jan. 30, 2008
(86) PCT No.: PCT/DE2008/000162

§ 371 Date: Aug. 13, 2009

(30) Foreign Application Priority Data
Feb. 17, 2007 (DE) 10 2007 007 960.7

(51) Int. Cl. F16J 9/26; F16J 9/14

(52) U.S. Cl. 277/443; 277/442; 277/444

(57) ABSTRACT

A piston ring, having a base body, which comprises a substantially circumferential running surface, which has an upper and a lower flank surface, an inner circumferential surface, and a butt opening provided with defined butt clearance, wherein the transition of the running surface butt edge into the respective butt surface is configured as a sharp edge, and the running surface is provide with at least one PVD cover layer ≦10 μm at least up to the respective running surface butt edge.

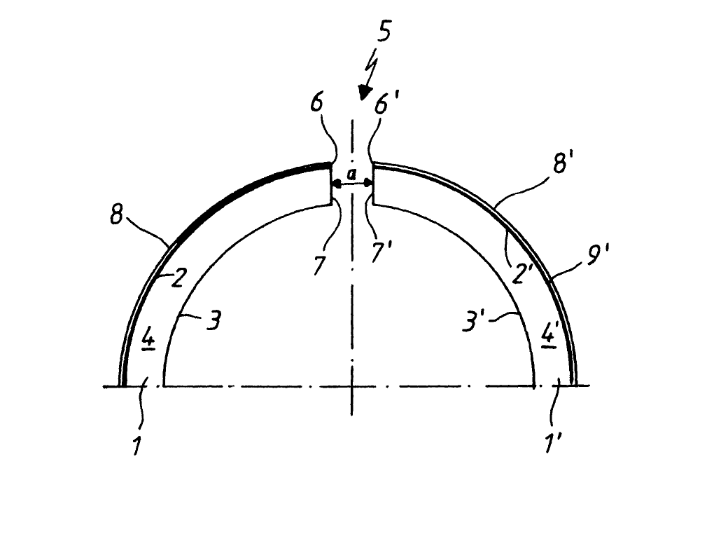

The invention concerns a piston ring, with a main body, which exhibits essentially a circular contact surface, an upper and a lower side surface, an inner circumferential surface, and a gap opening exhibiting a defined gap.

Aside from the gap, the size of the gap chamfer has a distinct edge effect on the quantity of gases flowing through the gap opening. For this reason, the dimensions of both features are to be kept as small as possible. Whereas the size of the gap depends, among other things, on the thermal expansion of the piston-ring material and the process reliability of the cutting procedure, the blow-by resistance of the contact-surface coating, or the tendency for crack formation in the wear-resistant layer is of decisive significance for the size of the gap chamfer.

Independently of whether the respective contact-surface coating is applied in a galvanic or thermal spray process or whether it is treated with a wear-resistant surface layer, which is produced through a nitriding treatment, the blow-by resistance or tendency to form cracks depends wholly and decisively on the thickness of the layer applied or formed.

There is a now conflict of goals here, since a thicker layer is needed on the contact-surface side for sufficient wear protection; however a thinner layer is preferable for blow-by resistance and a low tendency toward crack formation.

The invention is based on the problem of a piston ring being developed, to the effect that in order to eliminate gap edge blow-by, a different type of contact-surface coating is prepared, this being accompanied by design changes in the area of the gap opening.

This problem is solved by means of a piston ring with a main body, which exhibits essentially a circular contact surface, an upper and a lower side surface, an inner circumferential surface, and a gap opening provided with a defined gap, whereby the transition from the contact-surface gap edge on the respective gap surface is formed as sharp edges and the contact surface at least is provided up to the respective contact-surface gap edge with at least one PVD coating layer of ≦10 μm.

Advantageous developments of the invention subject matter may be inferred from the subclaims.

Physical-vapor-deposition (PVD) coating is a process in which the coating of the contact surface of the piston ring occurs by means of deposition from the vapor phase. The coating material being deposited exists, at the same time, as a stream of ionized particles.

In the PVD process, coating layers being deposited are preferably formed on a base of CrN, CrON, TiN, SiN, or SiC, which are very hard and thus wear-resistant. For this reason, such layers of ≦10 μm can be deposited either directly onto the main body or else with at least one wear-protection layer applied thereon.

Herewith is a further advantage, that the respective wear-protection layer with a thickness less than that previously used can also suffice, whereby preferred thicknesses of ≦15 μm, in particular 5 to 10 μm, are targeted.

As a result of the small-sized PVD coating layer, it is now possible to form very sharp edges at the gap ends of the piston ring, so that gap-edge blow-by can be considerably reduced in comparison with prior art, to the effect that an increased blow-by resistance occurs in the contact-surface layer, particularly in the critical gap region.

By means of the measures taken according to the invention, the conflict of goals addressed at the beginning is overcome, since PVD coating layers, alone or as a coating layer of very thin galvanic, thermal, or nitrided wear-protection layers, even with a very slight thickness, guarantee sufficient wear protection for the stresses in modern combustion engines.

As a further idea according to the invention, the PVD coating layer can be produced on a base of nitrides of elements in groups IV B to VI B of the periodic table. This can occur optionally with or without the addition of the elements Al and/or Si and/or C and/or O.

Especial advantageous are so-called diamond-like carbon (DLC) coatings, which are applied to the contact surface of piston rings in the PVD process. They form especially wear-resistant surfaces with a low coefficient of friction. DLC layers exhibit in addition good adhesion to the main body and a high rupture strength.

The subject matter of the invention is represented with the aid of one embodiment in the drawing and is described as follows.

The sole FIGURE shows in plan view two piston-ring halves outlined for a piston ring 1,1′ made of steel, cast steel, or cast iron. Seen are the contact surfaces 2,2′, the inner circumferential surface 3,3′, the upper side surface 4,4′, and a gap opening 5 with a defined gap a. The transition of the contact-surface gap edge 6,6′ at the anvil face 7,7′ is formed as sharp edges.

The piston ring 1 in this example is merely provided with a PVD coating layer 8, which is formed on a base of CrN and exhibits a layer thickness of 10 μm. Other materials, such as CrON, for example, are also conceivable, whereby the professional expert makes a suitable choice of material, depending on the application.

The piston ring 1′ exhibits on its contact surface 2′ a wear-protection layer 9′, on which a PVD coating layer 8′ is deposited. The wear-protection layer 9′ may be, in this example, a nitrided layer with a thickness of 30 μm, whereas the PVD coating layer 8′ is formed on a CrON base. The PVD coating layer 8′ in this example has a layer thickness of 8 μm. As stated previously, alternative PVD coating layers are conceivable here as well. Similarly for the wear-protection layer 9′, which can be applied galvanically or thermally as required to the contact surface 2′.

The combination of the contact-surface gap edge 6,6′ formed with sharp edges in connection with the thin PVD coating layer 8,8′ alone or in connection with the also small-sized wear-protection layer 9′ now makes it possible to minimize the size of a gap-edge chamfer or to completely eliminate it in this area, so that the blow-by resistance of the PVD coating layer 8,8′ relative to the tendency for crack formation in the wear-protection layer 9′ is increased compared to the wear-protection layers used up to now.

1. A piston ring, with a main body, which exhibits an essentially circular contact surface, an upper and a lower side surface, an inner circumferential surface, and a gap opening provided with a defined gap, in which the transition of the contact-surface gap edge at the respective gap surface is formed as sharp edges and the contact surface is provided, at least up to the respective contact-surface gap edge, with at least one PVD coating layer of ≦10 μm.

2. A piston ring according to claim 1, wherein the PVD coating layer is formed on a base of at least one of CrN and CrOn.

3. A piston ring according to claim 1, wherein the PVD coating layer is on a base of nitrides of elements in groups IV B to VI B of the periodic table.

4. A piston ring according to claim 1, wherein the PVD coating layer is formed as a friction- and wear-resistant PVD-DLC (diamond-like carbon) layer.

5. A piston ring according to claim 1, wherein the PVD coating layer exhibits a layer thickness of 0.5 to 8 μm.

6. A piston ring according to claim 1, wherein the main body is fabricated of consisting of cast iron or cast steel and, exhibits at least one wear-protection layer on the contact-surface side, onto which the PVD coating layer is deposited.

7. A piston ring according to claim 6, wherein the wear-protection layer is applied galvanically or thermally or by nitriding to the contact surface.

8. A piston ring according to claim 6, wherein the wear-protection layer exhibits a thickness of ≦30 μm.

9. A piston ring according to claim 3, including addition of at least one element to the base of nitride elements selected from the group consisting of Al, Si, C and O.
